(19) United States
(12) Patent Application Publication
(10) Pub. No.: US 2006/0088026 A1
(43) Pub. Date: Apr. 27, 2006

(54) Message based network configuration of domain name services

(75) Inventors: Leszek Mazur, Bellevue, WA (US); Theodore H. Roberts III, Sammamish, WA (US); Kevin T. Damour, Bellevue, WA (US); Lingan Satkunanathan, Kirkland, WA (US); Neil S. Fishman, Bothell, WA (US); Scott A. Manchester, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/974,182

(22) Filed: Oct. 27, 2004

(51) Int. Cl. H04L 12/66

(52) U.S. Cl. 370/352

(57) ABSTRACT

Systems and methodologies that facilitate hosting of a domain name and access of users to the internet, by using a well defined protocol to interact with a plurality of Domain Name Service (DNS) providers, via employing; a purchasing component, and a configuration component. Once a user has selected a domain name, the purchasing component can automatically query the provider(s) for terms of the service plan to host such domain name. The configuration component can configure various records to a user's designated machines or IP addresses, to manage in-bound traffic to the user's domain name.

### TECHNICAL FIELD

The subject invention relates generally to purchase, set up and configuration of Domain Name Services (DNS) for networks and servers, and more particularly to systems and methods that facilitate purchase, remote configuration and maintenance of DNS providers that host a domain name, via a structured messaging format and protocol.

### BACKGROUND OF THE INVENTION

Increasing advances in computer technology (e.g., microprocessor speed, memory capacity, data transfer bandwidth, software functionality, and the like) have generally contributed to increased computer application in various industries. Ever more powerful server systems, which are often configured as an array of servers, are often provided to service requests originating from external sources such as the World Wide Web, for example.

At the same time, the rapid growth of the Internet and Internet based applications has created a multitude of benefits for businesses, such as ease of marketing and sales to clients. In such environments, a Domain Name Service (DNS) provider allows potential clients to key a URL (Uniform Resource Locator) or domain name into the address line of their browser and access a corresponding server of the business.

In general, a Domain Name Service (DNS) includes distributed set of servers primarily used by internet applications to lookup the network address of a given internet server. For example, an internet application that requires to look up a server name initially can send a DNS query to a local Domain Name server (LDNS), which may be located at the same site. The LDNS can also maintain a cache of resource records, for example, mappings between server names and IP addresses. To facilitate mnemonic identification of destination computer systems, a Domain Name Service (DNS) can typically translate a unique textual name for a destination computer system into the IP address for that computer. The textual name is called a “domain name.”

As such, the basic function of DNS is to provide a distributed database that maps between human-readable host names and IP addresses. The DNS name space can be hierarchically organized so that subdomains can be locally administered. The root of the hierarchy can be centrally administered and served from a collection of root servers. In addition, sub domains can be delegated to other servers that are authoritative for their portion of the name space, and such process can be repeated recursively.

An example of a domain name is “www.Microsoft.com”, wherein, “www” indicates World-Wide Web, “Microsoft” indicates an example of a company name, .com indicates commercial (as opposed to .gov for government entities, .edu for education entities, org for non-profit organizations, and the like). Likewise, progressing from right to left, the host name can be structured from general to very specific. For example, “com” can typically be referred to as a top-level domain name, “Microsoft” is sometimes referred to as a second-level domain name, and “www” can designate the server that handles Internet requests, and is sometimes referred to as a third-level domain name.

An example of a URL is “http://www.Microsoft.com/1.gif”, where the “http://” indicates the type of resource and the last field, “1.gif”, indicates a file name, but may also be a Web page, executable application, or other computer readable or executable file located at the URL that the user wishes to access.

When the user enters the URL into a browser, the browser can make a determination as to whether it knows a corresponding IP (Internet Protocol) address. For example, a corresponding IP address for “Microsoft.com” may be 207.46.130.108. The browser knows the corresponding IP address if that host name has been visited recently and the address is still in a short-term host name address table in the browser.

At the same time, generally, required steps for an internet presence includes purchasing a domain name, configuration of the DNS services, certification purchase procedures, and the like. Such numerous steps can typically include cumbersome procedures, such as manual configuration, which can be susceptible to errors. In addition, some users (e.g., small business owners) may be unfamiliar with such procedures and may require expert help that can be time consuming and increase users' set up costs.

For example, before a small business can initiate a presence electronically on the Internet and the World Wide Web, such a business is often required to purchase a domain name and register with a DNS provider to host such domain. To do so, a representative of the small business can be required to initiate communication (e.g., via telephone, fax, mail and the like) with a representative of the DNS provider in order to establish an account therewith. During such communication, the DNS representative is provided with general information (e.g., name, address, business type and the like) and a form of payment (e.g., a credit card number). In return, the DNS provider can supply the user with a username and password that can be employed to authenticate the user and authorize presence of the domain name on the Internet. Hence, the different presentation of the plan options offered by the various DNS providers can be confusing to a user and require cumber some registration steps.

Moreover, each provider of DNS can require loading and implementing specialized proprietary software/procedures that can further complicate matters, and impede a user's ability to accurately compare plans offered by DNS providers. Such disparate configuration tools can thwart users from employing opportunities provided by the internet to their full potentials. For example, the DNS provider can send, via a postal or other delivery service, proprietary software (e.g., certification software) that may need to be installed on a computer system prior to hosting the domain name by the DNS provider. Any such associated software and/or hardware must be correctly installed on the computer system, in order for the user of small business to enjoy benefits of a domain name and thereby presence on the Internet. Thus, such a user is generally required to wait until such software and hardware is received. Thereafter, the user must correctly install the associated software and/or hardware at the computer system to enable Internet presence.

If correctly installed, a user can configure inbound traffic, and interact with the DNS provider. In order to support secure web traffic, the user must also obtain proper certificate provisions via third parties for the domain name of the user. Obtaining such certificate can further add to the complexities of establishing presence on the internet.

Thus and as explained above, users wishing to enjoy presence of their domain names on the Internet can typically be subjected to: non-uniform presentations in a multi-vendor environment, cumber some contacting requirements, waiting periods for appropriate access software and/or hardware to be delivered or installed.

Therefore, there is a need to overcome the aforementioned exemplary deficiencies associated with conventional systems and devices.

### SUMMARY OF THE INVENTION

The following presents a simplified summary of the invention in order to provide a basic understanding of one or more aspects of the invention. This summary is not an extensive overview of the invention. It is intended to neither identify key or critical elements of the invention, nor to delineate the scope of the subject invention. Rather, the sole purpose of this summary is to present some concepts of the invention in a simplified form as a prelude to the more detailed description that is presented hereinafter.

The subject invention provides for systems and methods that facilitate hosting of a domain name and presence of users on the internet, by using a schema that operates between an end user machine and a plurality of Domain Name Service (DNS) providers, wherein the schema employs; a purchasing component, and a configuration component. The purchasing component can further include various sub components that characterize the DNS providers' offered term of sale for service agreement of hosting the domain name, such as; billing, plan selection, renewal, promotional calls, and the like. Also, a status query can be performed as part of the purchase to verify that the user is in fact entitled to the domain name for which hosting is required. Likewise, the configuration component can include various sub components that configure the mail exchange records (MX records), the address records (A records), the canonical or reference name records (CNAME records) and the like, to a user's designated machines or IP addresses, to manage in-bound traffic to the user's domain name.

In accordance with an aspect of the subject invention, a plurality of third party DNS providers can register and receive a standardized set of messages for hosting a domain name(s) obtained by a user. Such standard messages can provide a user with a uniform presentation of various plans offered by the plurality of the DNS providers, wherein the user can then select a desired plan therefrom for hosting the domain name. The standardized messages can be for example in a form of XML (Extensible Markup Language).

The invention thus facilitates initial server configurations (e.g., presence of small businesses on the internet), and on-going maintenance, wherein employing multi vendor components are simplified by using a unified and common message structure. Such unified and common message structure can be used by a plurality of end user networked devices such as stand alone routers, window servers, and the like when interacting with third party DNS providers.

According to a methodology of the subject invention, once a user has selected a domain name, the purchasing component can automatically query the provider(s) for terms of the service plan to host such domain name. The terms can include; duration for hosting the domain name, price, terms of payments and the like. Subsequently, a response to such query can be received by the end user machine. A billing query can automatically then be prepared and submitted to the DNS provider(s). Next, the DNS provider(s) can provide a billing response that outlines the service agreement terms for hosting such domain name. The received response can then be displayed to a user, via a uniform presentation such that a user enjoys a similar experience, regardless of which DNS provider the user interacts with. Next, the user can elect a desired plan to initiate internet presence.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 illustrates a schematic block diagram of components associated with a messaging schema exchanged between an end user machine and a Domain Name Service (DNS) provider, in accordance with an aspect of the subject invention.

FIG. 2 illustrates a plurality of sub components associated with the purchasing component in accordance with an aspect of the subject invention.

FIG. 3 illustrates yet another schematic block diagram of a purchasing component in accordance with the subject invention.

FIGS. 4(a) & 4(b) illustrate a sequence of query steps performed between the end user machine and the DNS provider in accordance with an aspect of the subject invention.

FIG. 5 illustrates an end user device that connects to the DNS provider in accordance with an aspect of the subject invention.

FIG. 6 illustrates a configuration component as part of the standardized messaging schema of the subject invention.

FIG. 7 illustrates a methodology of hosting a domain name with a DNS provider registered to receive the standardized set of messages in accordance with an aspect of the subject invention.

FIG. 8 illustrates an exemplary graphical uniform interface employed for presentation of various plans offered by the plurality of the DNS providers.

FIG. 9 illustrates a schematic diagram of providing an end user presence on the internet via employing a multi vendor component.

FIG. 10 is a schematic block diagram illustrating a suitable computing environment that can employ various aspects of the subject invention.

FIG. 11 illustrates a client—DNS provider system that can employ a messaging schema according to one aspect of the subject invention.

Appendix A presented infra provides one particular exemplary set of schema in accordance with an aspect of the subject invention—this appendix is to be considered part of this specification describing the invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component,” “handler,” “model,” “system,” and the like are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal).

The subject invention provides for a standardized messaging schema that facilitates hosting of a domain name, and presence of users on the internet, by using a well defined protocol to interact with a plurality of Domain Name Service (DNS) providers, via employing; a purchasing component, and a configuration component. Such a messaging schema can further provide for a uniform presentation of various hosting plans offered by a plurality Domain Name Service (DNS) providers, and thus a user can enjoys a similar experience, regardless of which DNS provider the user interacts with.

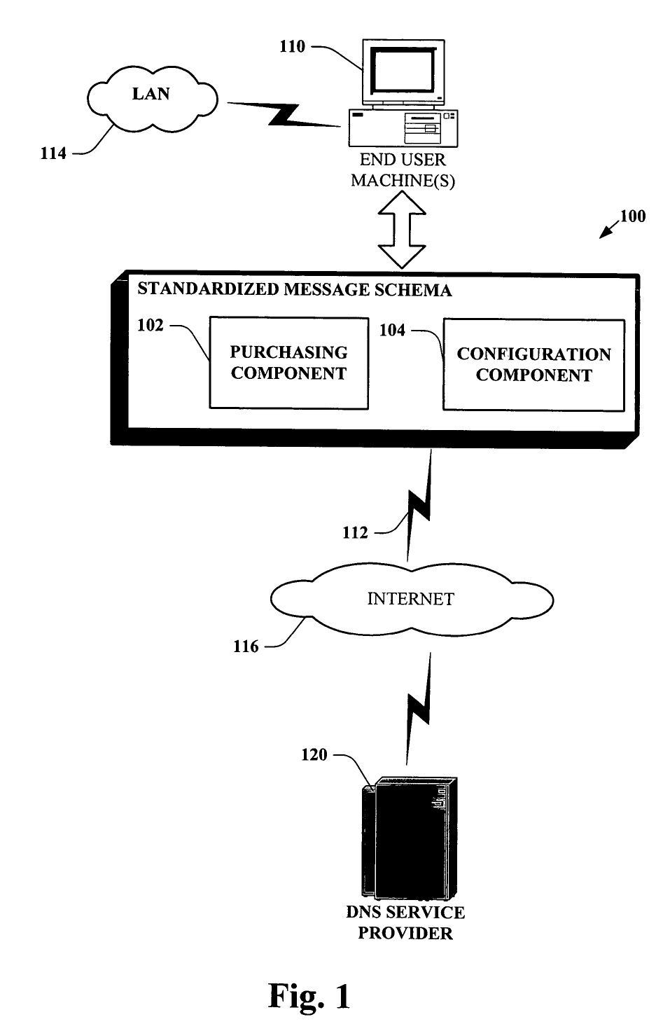

Referring initially to FIG. 1, a block diagram of a messaging protocol 100 for interaction between an end user machine 110 and Domain Name Service (DNS) provider(s) 120 is illustrated. Such messaging protocol can include a purchasing component 102 and a configuring component 104, which are part of a standardized set of messages transferred between the DNS provider(s) 120 and an end user device 110.

The end user machine 110 can be a personal computer, work stations personal digital assistant, and the like. In addition, the end user machine 110 can also be an Internet Connection Sharing Device (ICSD) that facilitates sharing a connection 112 from a network 114 to the Internet 116. As such, the end user machine 110 can be a computer executing a process that facilitates time-sharing or frequency sharing of the Internet connection 112, for example. The connection 112 can be, for example, a modem connection, a DSL connection and/or a wireless connection. The network 114 can be, for example, an Ethernet LAN, a token ring LAN, or other LAN. Although the invention is primarily described within the context of an end user machine 110 that communicates with a Domain Name Service (DNS) provider 120, it is to be appreciated that the network 114 can also include a Wide Area Network (WAN). Moreover, the network 114 can include hardwired and/or optical and/or wireless connection paths. The connection 112 can be shared among a plurality of devices connected to the network 114. Such devices can include, personal computers, workstations, televisions and telephones, for example. Sharing of the connection 112 facilitates reducing the cost of one or more of the LAN devices, and can reduce the complexity of managing the network 114 and optimizes the throughput of the connection 112.

Likewise, the DNS provider 120 can provide access to a distributed Internet directory service (not shown), while translating between domain names specified by the user with its IP addresses, and further controlling in bound traffic (e.g., Internet email delivery). Typically, most Internet services rely on DNS to work, and if DNS fails, web sites cannot be located and email delivery stalls.

Once the DNS 120 provider registers to receive the standardized messages of the subject invention, a user can select such provider to offer plans for hosting the domain name selected by the user. Each plan can have a plurality of terms and conditions such as, duration, price and the like associated therewith. Upon selection of a plan by the user, the DNS provider can then configure the DNS server (not shown) at the back end.

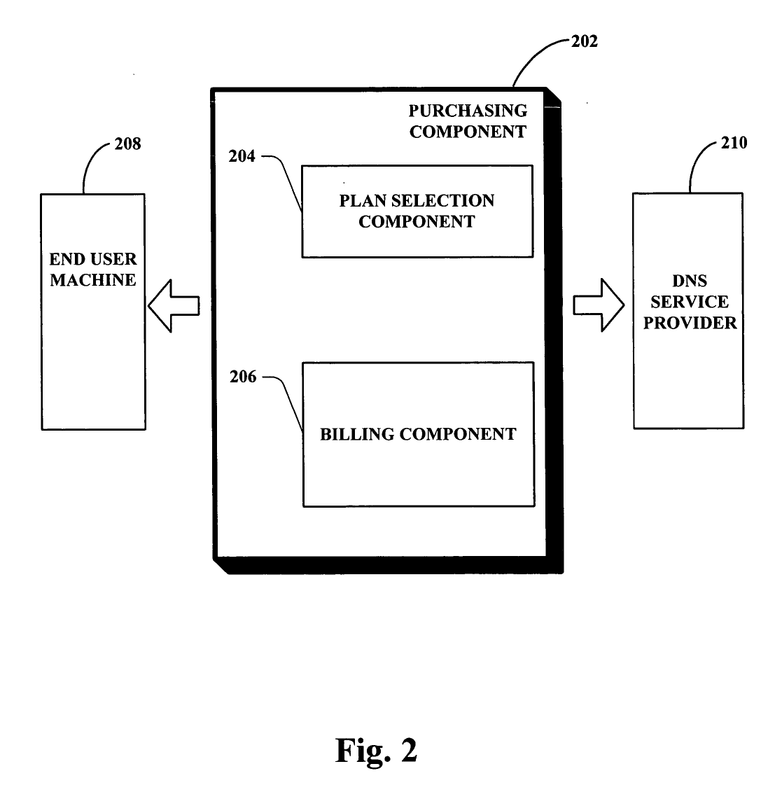

Referring now to FIG. 2 various sub components that can be associated with the purchasing component 202 is illustrated. Such purchase component 202 can further include a plan selection component 204, and a billing component 206. The purchasing component 202 can query the DNS service provider 208 for a list of plan offerings and terms of the service agreement that are associated with the plan selection component 204. Such can include: the duration of hosting the domain name previously obtained by the user, whether a transfer of the domain name is required from another DNS provider, designation of the DNS provider, identification of the top level domain name (TLD), a language hint that designates to the DNS provider 208 what language the server can employ, renewal options, promotional calls and the like.

An exemplary schema that can define an expression of shared vocabulary between the end user machine 208 and DNS provider 210 is presented at the end of this document, as part of appendix A. Such exemplary schema can for example be in form of an Extensible Markup Language (XML) that can define and describe a class of XML documents using schema constructs of an XML schema language. These schema constructs can be used to constrain and document the meaning, usage, and relationships of data types, elements and their content, attributes and their values, entities and their contents, and notations, as used in XML documents. Thus, in general any computer system that can access an XML schema can process XML documents in accordance with the XML schema. Furthermore, typically any computer system that can access an XML schema can compose or modify XML documents for use by other computer systems that can also access the XML schema. A schema can be utilized to define virtually any data type including logical, binary, octal, decimal, hexadecimal, integer, floating-point, character, character string, user-defined data types, and combinations of these data types used to defined data structures. XML elements and attributes can be defined to represent data types that are defined by a schema.

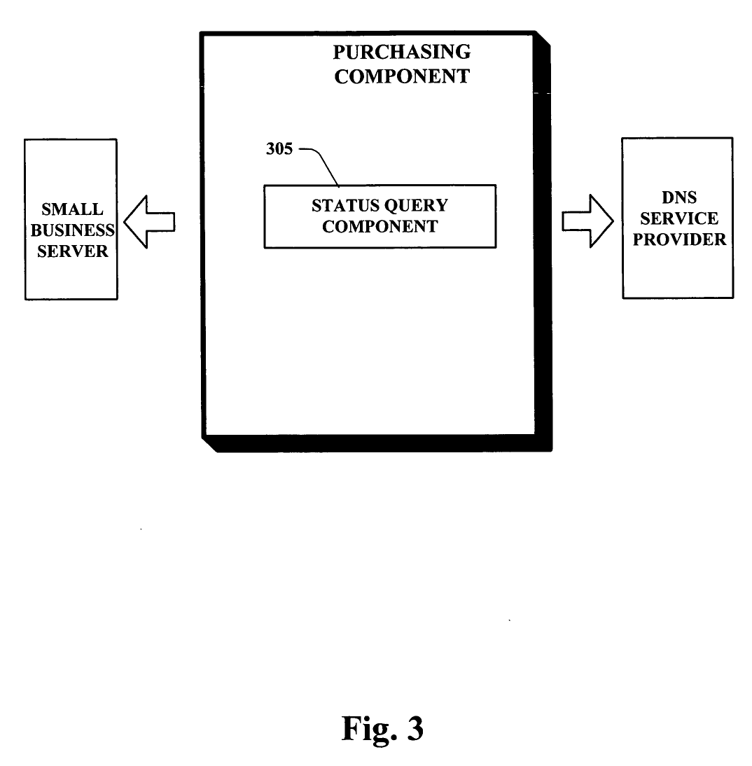

In a related aspect of the subject invention, the purchasing component can further include a status query component 305 as illustrated in FIG. 3. Such status query component 305 can verify whether a domain name requested to be hosted by user is in fact owned by such user, and that the entitlement is valid.

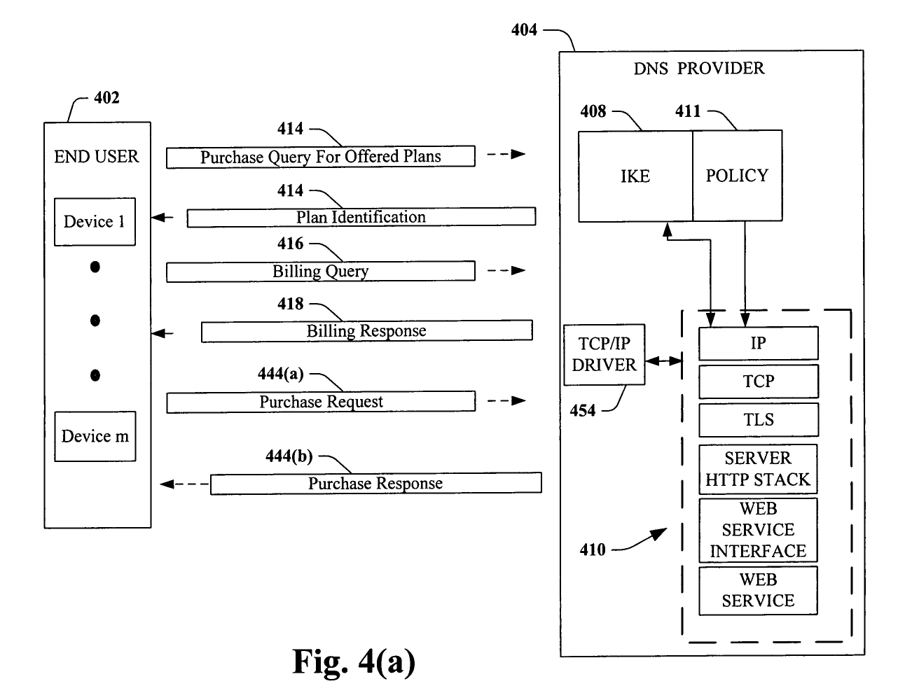

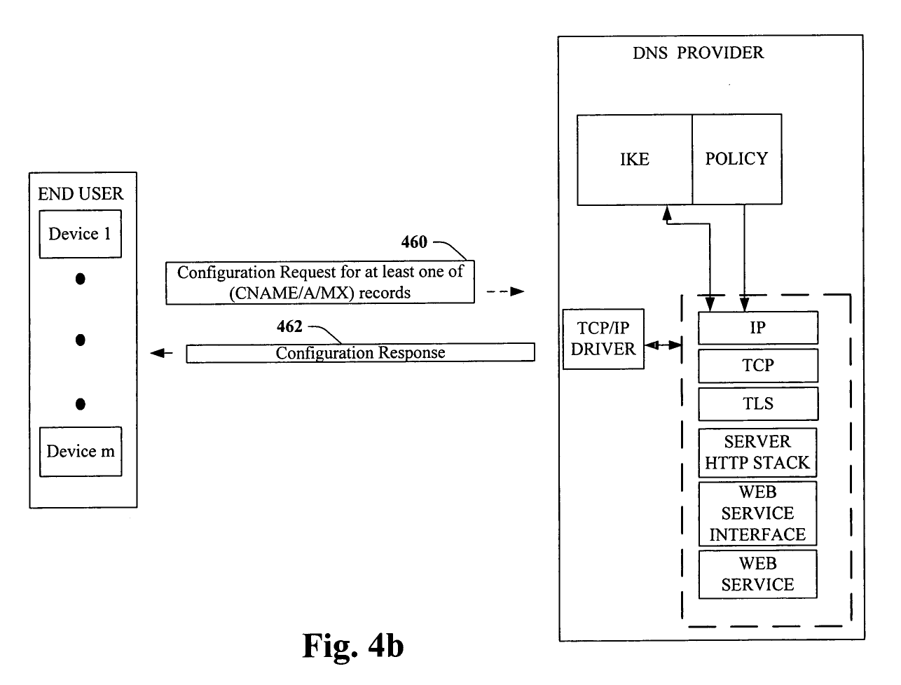

FIG. 4(a) illustrates a sequence of query steps between end user machines 402 (1 thru m, m being an integer) and a DNS provider 404. The DNS provider 404 can include a service side secure network stack 410 that further includes an IP layer implementation, a service side TCP layer implementation, a service side TLS, an HTTP stack implementation, a web service provider interface and a web service. The DNS provider 404 can include an Internet Key Exchange (IKE) subsystem 408 for securing network traffic between the DNS provider 404 and the end user devices 402. The DNS provider 404 can also include policy modules 411 to enable configuration of the IKE subsystems 408. The policy module 411 can also provide security configuration information to the secure network stack 410 which communicate via TCP/IP driver 454 thereby enabling secure network traffic between the DNS provider 404 and the end user machines 402.

The DNS provider 404 can register and receive the standardized set of messages for hosting a domain name(s) obtained by a user. For example, at 414 the purchasing component of the standardized schema of the subject invention can query the DNS provider(s), which are registered for receiving the standardized messages for a purchase query of the various plan offerings. Next, and at 416 a purchase query response identifying the various plans and terms of the service is communicated via the standardized set of messages of the subject invention back to the end user machine. Subsequently and at 416, a billing query is transferred to the DNS provider 404. A response can then be prepared and sent back to the end user machine regarding various billing requirements for hosting the domain name. The received response can then be displayed to a user, via a uniform presentation such that a user enjoys a similar experience, regardless of which DNS provider the user interacts with. The user can then select a desired plan for purchase, with a purchase request/response pair 444(a) & 444(b) exchanged between the DNS provider 404 and the end user machine(s) 402. Likewise, FIG. 4(b) illustrates an exemplary sequence for configuring the various records, such as the mail exchange records (MX records), the address records (A records), the canonical or reference name records (CNAME records) and the like, to a user's designated machines or IP addresses, to manage in-bound traffic to the user's domain name. As such, a configuration request can be sent at 460, with a configuration response generated at 462.

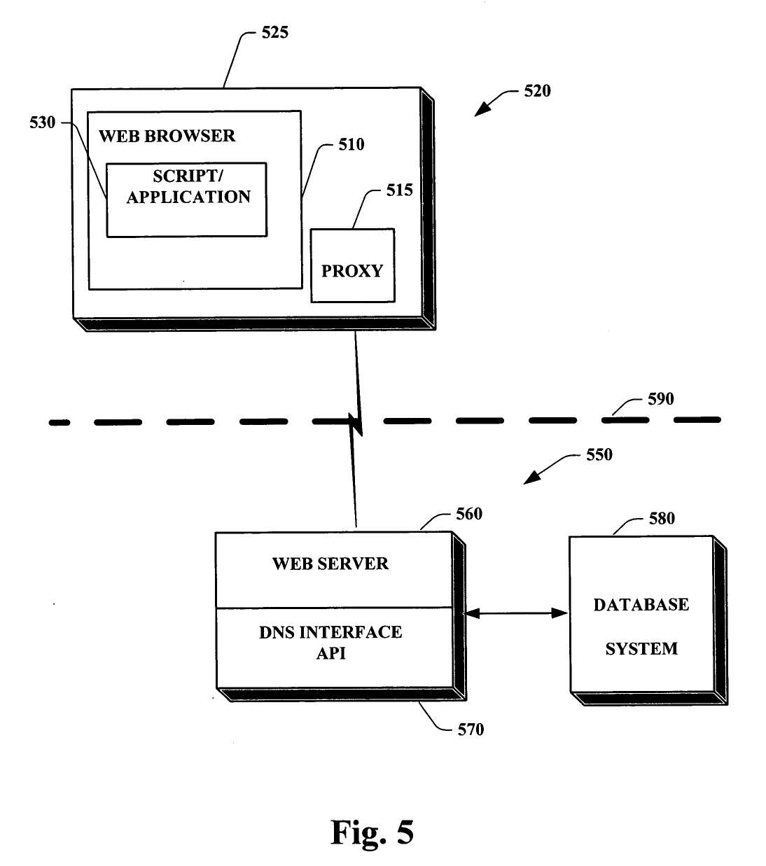

FIG. 5 illustrates an end user device that connects to the DNS provider in accordance with an aspect of the subject invention, wherein running on the end user side 520 can be a client process, for example, a web browser 510. Likewise, running on the DNS provider side 550 can be a corresponding server process, for example, a web server 560. In addition, embedded in the Web Browser 510 can be a script or application 530, and running within the run-time environment 525 of the end user device 520, can exist a proxy 515 for packaging and unpacking data packets formatted in accordance with the standardized messages of the subject invention. Communicating with the DNS provider can be a database management system (DBMS) 580, which manages access to a Content database of domain names. The DBMS 580 and the database (not shown) can be located in the DNS provider itself, or can be located remotely on a remote database server (not shown). Running on the Web server 560 can be a DNS interface Applications Programming Interface (API) 570, which provides access to the DBMS 580. The end user device 520 and the DNS provider 550 can communicate with each other through a network 590, (e.g., the internet). When the client process, e.g., the Web browser 510, requests a query of service plans from the DNS provider, the script or application 530 can issue a query, which is sent across the network (e.g., internet) 590 to DNS provider side 550, where it is interpreted, e.g., the Web server 560. The end user's 520 request to the DNS provider 550 can contain multiple commands, and a response from DNS provider 550 can return a plurality of service plan options. The received response can then be displayed to a user, via a uniform presentation such that a user enjoys a similar experience, regardless of which DNS provider the user interacts with. The invention thus facilitates initial server configurations (e.g., presence of small businesses on the internet), and on-going maintenance, wherein employing multi vendor components are simplified by using a unified and common message structure.

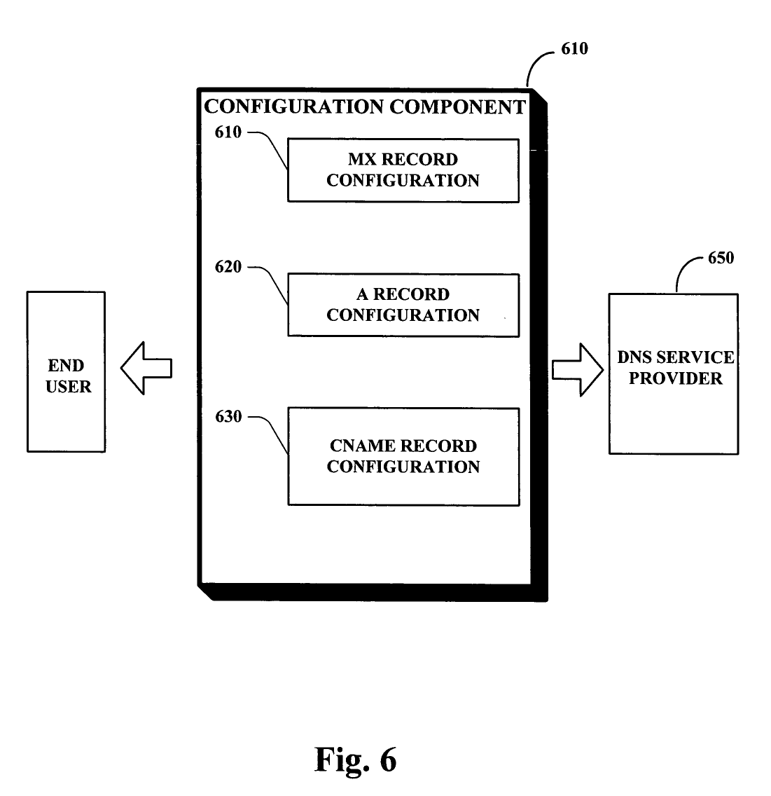

Referring now to FIG. 6, a configuration component is illustrated as part of the standardized messaging of the subject invention. Such configuration component 610 can provide a pointer to the designated IP address(es) of the end user. For example, mail exchange records (MX records) that is a mail exchanger query for the domain name (designated earlier by the end user), which reveals and directs that mail sent to a domain name to a particular IP address, can be configured by component 610. Like wise, the address records (A records) being a simple query for the IP address, can be configured via component 620 of the standardized schema in accordance with an aspect of the subject invention. Similarly, as a given host can have several DNS names, with one of such names being the canonical or reference name (CNAME records), such record can be configured via component 630 as part of the standardized messaging schema. It is to be appreciated that other type of records associated with hosting a domain name (e.g., an HINFO query and relevant records) can also be configured via a respective component (not shown) designated in the standardized schema, and is within the realm of the subject invention.

Typically, the basic function of the DNS provider 650 is to provide a distributed data base that maps between human readable host names and IP addresses as well as mail routing information. As such, a DNS name space can be hierarchically organized, so that sub-domains can be locally administered, wherein for any group of computers partaking of the DNS naming scheme there can be a single definitive list of DNS names and associated IP addresses. The group of computers included in such list is called a zone. A zone could be a top level national domain, a business and the like. Within a zone DNS service for subsidiary zones can be delegated along with a subsidiary domain, and the computer that maintains the master list for a zone is said to have authority for that zone, e.g., will be the primary name server for that zone, there will also be secondaries for that zone. When any process needs to determine an IP address given a DNS address it calls upon the local host to resolve the address. This can be done in a variety of ways.

For example, when a client searching for a business related to the end user of the subject invention enters a designated domain name (e.g., enduserbusiness.com), which is being hosted by the DNS provider, a local server associated with the client is queried for such name. If such server does not know about such domain name, it will then ask the root server. The root server can then refer such query to the “.com” server, which in turn refers to the enduserbusinnes.com, which responds with an address. An exemplary XML schema for the configuration component, (as well as for the purchasing component described supra) is presented as part of appendix A—infra.

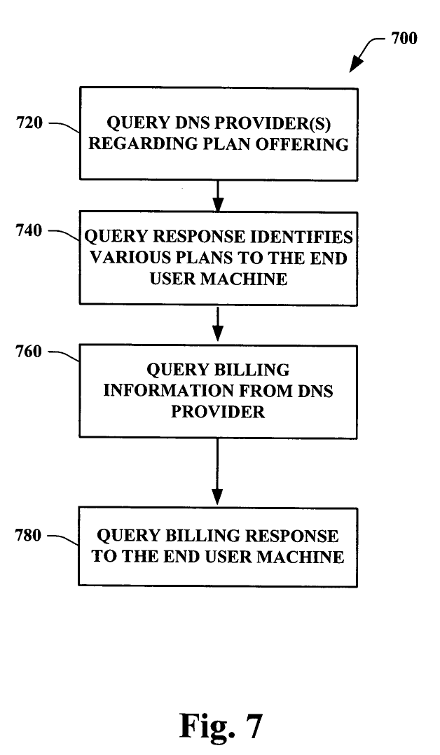

FIG. 7 illustrates a methodology of hosting a domain name with a DNS provider registered to receive standardized set of messages in accordance with an aspect of the subject invention. Initially, and at 720 the purchasing component, as part of the standardized message schema of the subject invention, can query the DNS provider(s) regarding the various plan offerings. In response to such query, and at 740 a purchase query response (e.g., data packets) identifying the various plans and terms of the service is communicated via the standardized set of messages of the subject invention back to the end user machine. Subsequently and at 760, a billing query is transferred to the DNS provider. A response can then be prepared and sent back to the end user machine regarding various billing requirements for hosting the domain name, at 780. The received response can then be displayed to a user, via a uniform presentation such that a user enjoys a similar experience, regardless of which DNS provider the user interacts with. The user can then select a desired plan for purchase, and initiate presence of its domain name on the web.

While the exemplary method is illustrated and described herein as a series of blocks representative of various events and/or acts, the present invention is not limited by the illustrated ordering of such blocks. For instance, some acts or events may occur in different orders and/or concurrently with other acts or events, apart from the ordering illustrated herein, in accordance with the invention. In addition, not all illustrated blocks, events or acts, may be required to implement a methodology in accordance with the present invention. Moreover, it will be appreciated that the exemplary method and other methods according to the invention may be implemented in association with the method illustrated and described herein, as well as in association with other systems and apparatus not illustrated or described.

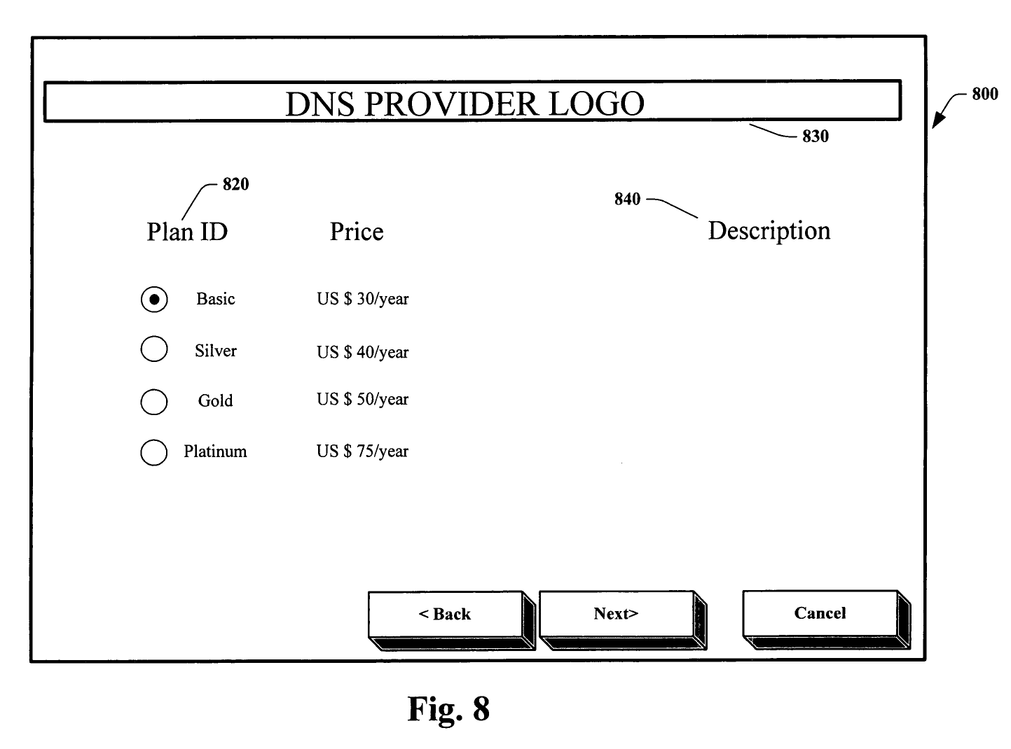

FIG. 8 illustrates an exemplary graphical uniform interface employed for presentation of various plans offered by the plurality of the DNS providers, wherein the user can then select a desired plan therefrom. Such graphical interface 800 displays returned results, and can provide a user with a uniform configuration tool for internet presence. The exemplary user interface (GUI) 800 of the subject invention can be employed to facilitate account generation for hosting of domain name service. Such GUI 800 comprises a identification region 820 for the various plans offered by a DNS provider. In addition, a space 830 can be reserved on the GUI 800 to display a logo associated with the DNS provider, with a description section 840 describing the nature of the plans offered. As such, a user can benefit from a similar experience regardless of which DNS provider the user interacts with. The user can then select a desired plan for purchase.

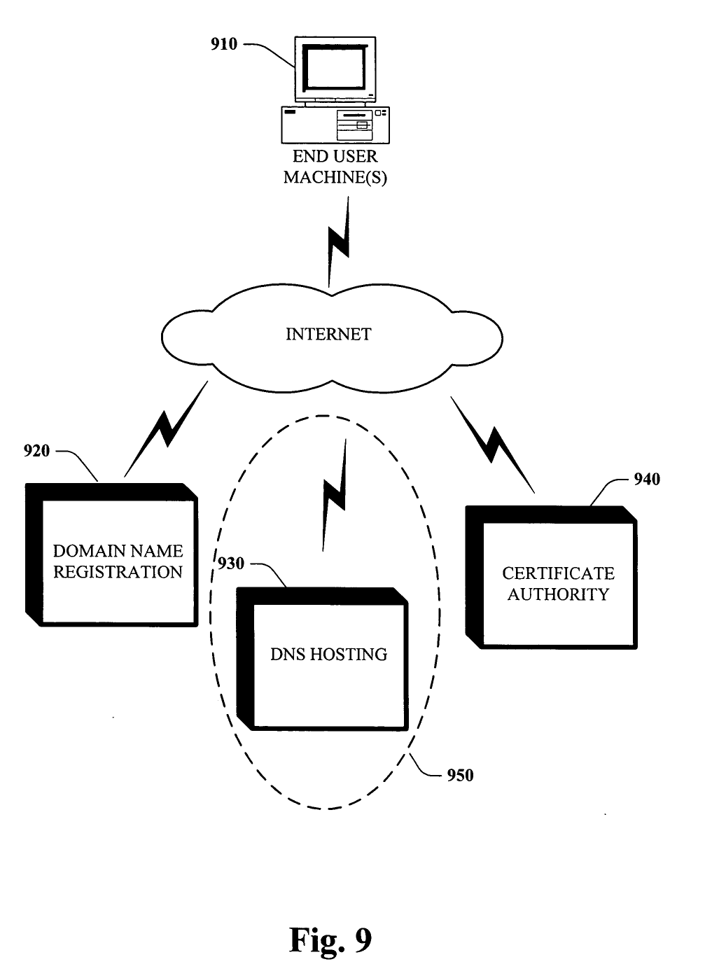

FIG. 9 illustrates a schematic diagram of providing an end user presence on the internet via employing a multi vendor component, wherein the subject invention primarily addresses the interaction 950 between an end user machine, such as a machine 910 ((e.g., small business computer) and a DNS provider 930. The end user machine 910 can interact with a plurality of vendors 920, 930, and 940 via the internet. Vendor 920 can primarily supply the end user with a domain name such as “mybusiness.com.”, and manages the various aspects of domain name registration. Upon obtaining such domain name, the end user can then seek and interact with various DNS providers 930 for hosing such domain name, as illustrated by the interaction at 950. During the interaction 950 a set of standardized messages, for example in the form of XML messages, are automatically exchanged between the end user machine and the DNS provider. Such standard messages can provide a user with a uniform presentation of various plans offered by the plurality of the DNS providers, wherein the user can then select a desired plan therefrom.

Similarly, vendor 940 can manage certificate authority and authenticating technologies such as Secure Sockets Layer (SSL) encryption with the domain name web site to verify validity (e.g., the website is trusted). Such technologies can verify a web site via ensuring the website is associated with a valid (e.g., signed) web site certificate. Generally, the web site certificate can provide web site identification, such as the web site's publisher, and can be employed to match a web site publisher with the certificate. When a match is successful, the web client is typically provided access to the web site. Accordingly, a user enjoys a similar experience, regardless of which DNS provider the user interacts with.

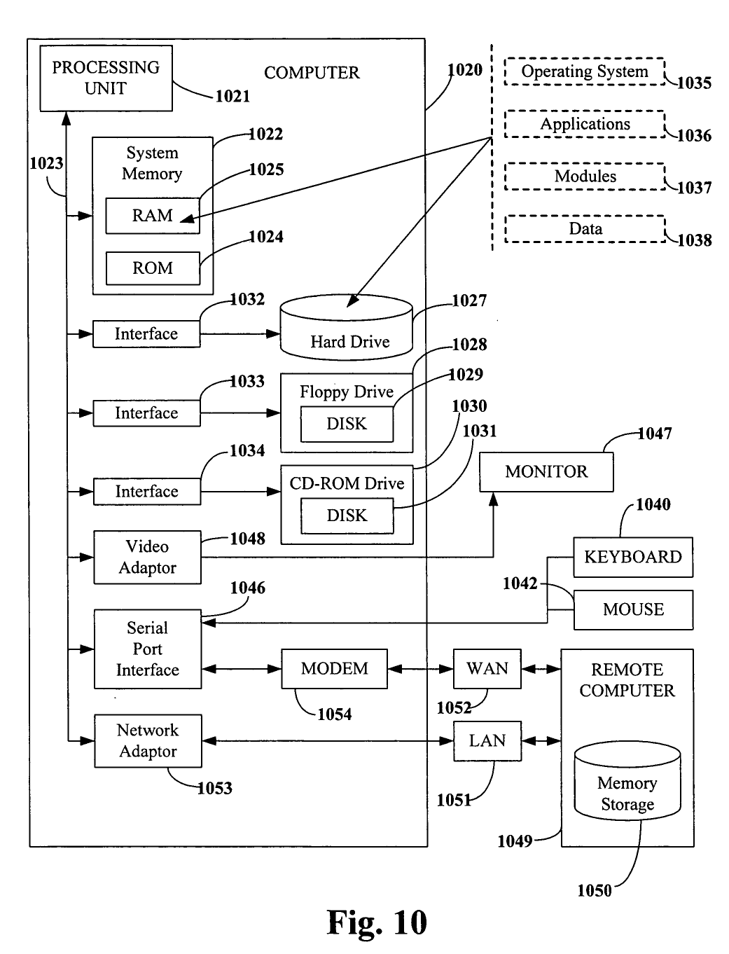

Referring now to FIG. 10, a brief, general description of a suitable computing environment on the client as well as the server side is illustrated wherein the various aspects of the subject invention can be implemented. While the invention has been described above in the general context of computer-executable instructions of a computer program that runs on a computer and/or computers, those skilled in the art will recognize that the invention can also be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like. As explained earlier, the illustrated aspects of the invention can also be practiced in distributed computing environments where tasks are performed by remote processing devices that are linked through a communications network. However, some, if not all aspects of the invention can be practiced on stand-alone computers. In a distributed computing environment, program modules can be located in both local and remote memory storage devices. The exemplary environment includes a computer 1020, including a processing unit 1021, a system memory 1022, and a system bus 1023 that couples various system components including the system memory to the processing unit 1021. The processing unit 1021 can be any of various commercially available processors. Dual microprocessors and other multi-processor architectures also can be used as the processing unit 1021.

The system bus can be any of several types of bus structure including a memory bus or memory controller, a peripheral bus, and a local bus using any of a variety of commercially available bus architectures. The system memory may include read only memory (ROM) 1024 and random access memory (RAM) 1025. A basic input/output system (BIOS), containing the basic routines that help to transfer information between elements within the computer 1020, such as during start-up, is stored in ROM 1024.

The computer 1020 further includes a hard disk drive 1027, a magnetic disk drive 1028, e.g., to read from or write to a removable disk 1029, and an optical disk drive 1030, e.g., for reading from or writing to a CD-ROM disk 1031 or to read from or write to other optical media. The hard disk drive 1027, magnetic disk drive 1028, and optical disk drive 1030 are connected to the system bus 1023 by a hard disk drive interface 1032, a magnetic disk drive interface 1033, and an optical drive interface 1034, respectively. The drives and their associated computer-readable media provide nonvolatile storage of data, data structures, computer-executable instructions, etc. for the computer 1020. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment, and further that any such media may contain computer-executable instructions for performing the methods of the subject invention.

A number of program modules can be stored in the drives and RAM 1025, including an operating system 1035, one or more application programs 1036, other program modules 1037, and program data 1038. The operating system 1035 in the illustrated computer can be substantially any commercially available operating system.

A user can enter commands and information into the computer 1020 through a keyboard 1040 and a pointing device, such as a mouse 1042. Other input devices (not shown) can include a microphone, a joystick, a game pad, a satellite dish, a scanner, or the like. These and other input devices are often connected to the processing unit 1021 through a serial port interface 1046 that is coupled to the system bus, but may be connected by other interfaces, such as a parallel port, a game port or a universal serial bus (USB). A monitor 1047 or other type of display device is also connected to the system bus 1023 via an interface, such as a video adapter 1048. In addition to the monitor, computers typically include other peripheral output devices (not shown), such as speakers and printers.

The computer 1020 can operate in a networked environment using logical connections to one or more remote computers, such as a remote computer 1049. The remote computer 1049 may be a workstation, a server computer, a router, a peer device or other common network node, and typically includes many or all of the elements described relative to the computer 1020, although only a memory storage device 1050 is illustrated in FIG. 10. The logical connections depicted in FIG. 10 may include a local area network (LAN) 1051 and a wide area network (WAN) 1052. Such networking environments are commonplace in offices, enterprise-wide computer networks, Intranets and the Internet.

When employed in a LAN networking environment, the computer 1020 can be connected to the local network 1051 through a network interface or adapter 1053. When utilized in a WAN networking environment, the computer 1020 generally can include a modem 1054, and/or is connected to a communications server on the LAN, and/or has other means for establishing communications over the wide area network 1052, such as the Internet. The modem 1054, which can be internal or external, can be connected to the system bus 1023 via the serial port interface 1046. In a networked environment, program modules depicted relative to the computer 1020, or portions thereof, can be stored in the remote memory storage device. It will be appreciated that the network connections shown are exemplary and other means of establishing a communications link between the computers can be employed.

In accordance with the practices of persons skilled in the art of computer programming, the subject invention has been described with reference to acts and symbolic representations of operations that are performed by a computer, such as the computer 1020, unless otherwise indicated. Such acts and operations are sometimes referred to as being computer-executed. It will be appreciated that the acts and symbolically represented operations include the manipulation by the processing unit 1021 of electrical signals representing data bits which causes a resulting transformation or reduction of the electrical signal representation, and the maintenance of data bits at memory locations in the memory system (including the system memory 1022, hard drive 1027, floppy disks 1028, and CD-ROM 1031) to thereby reconfigure or otherwise alter the computer system's operation, as well as other processing of signals. The memory locations wherein such data bits are maintained are physical locations that have particular electrical, magnetic, or optical properties corresponding to the data bits.

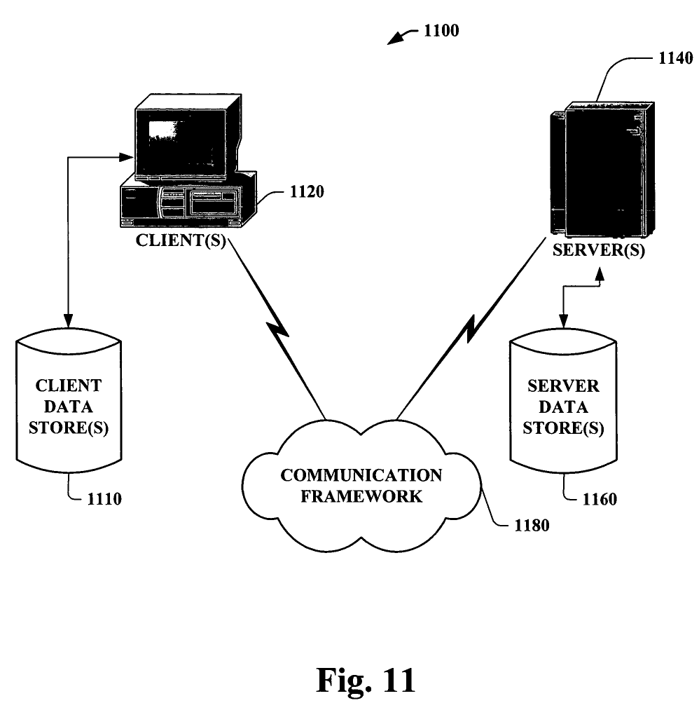

Referring now to FIG. 11, a client—DNS provider system 1100 that employs a standardized schema according to one aspect of the subject invention is illustrated. The client(s) 1120 can be hardware and/or software (e.g., threads, processes, computing devices). The system 1100 also includes one or more server(s) 1140. The server(s) 1140 can also be hardware and/or software (e.g., threads, processes, computing devices). For example, such servers 1140 can house threads to perform transformations by employing the subject invention. The client 1120 and the server 1140 can communicate, in the form of data packets transmitted according to the subject invention, between two or more computer processes. The client/server can also share the same process. As illustrated, the system 1100 includes a communication framework 1180 that can facilitate communications between the client(s) 1120 and the server(s) 1140. The client(s) 1120 is operationally connected to one or more client data store(s) 1110 that can store information local to the client(s) 1120. Moreover, client 1120 can access and update databases 1160 located on a server computer 1140 running a server process. In one aspect of the subject invention, the communication frame work 1180 can be the internet, with the client process being a Web browser and the server process being a Web server. As such, a typical client 1120 can be a general purpose computer, such as a conventional personal computer having a central processing unit (CPU), system memory a modem or network card for connecting the personal computer to the Internet, and a display as well as other components such as a keyboard, mouse, and the like. Likewise a typical server 1140 can be university or corporate mainframe computers, or dedicated workstations, and the like.

A sample XML schema that provides an example for the various components according to the subject invention is provided infra, as part of appendix A, and this appendix is to be considered part of this specification describing the invention.

Moreover, although the invention has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention. Furthermore, to the extent that the terms “includes”, “including”, “has”, “having”, and variants thereof are used in either the detailed description or the claims, these terms are intended to be inclusive in a manner similar to the term “comprising.”

What is claimed is:

1. A system that facilitates a user interaction with a Domain Name Service (DNS) provider comprising:
a standardized message schema exchanged between the DNS provider and a machine of the user, the schema comprising:
a purchasing component that characterizes a service agreement of the DNS provider; and
a configuration component that configures a DNS record of the DNS provider to manage inbound traffic to a domain name of the user.

2. The system of claim 1, the standardized message schema is in a form of an extensible mark up language.

3. The system of claim 1, the standardized message schema provides the user with a uniform presentation of plans when interacting with a plurality of DNS providers.

4. The system of claim 1, the record is at least one of a mail exchange record, an address record, and a canonical name record.

5. The system of claim 1, the purchasing component characterizes at least one of a plan selection, renewal option, promotional call and a billing plan.

6. The system of claim 1, the purchasing component performs a status query to verify ownership of the domain name.

7. The system of claim 1, the configuration component identifies an IP address for the user machine.

8. The system of claim 1, the machine and the DNS provider communicate over the internet.

9. The system of claim 8, the machine of the end user is at least one of a personal computer, work station, and an internet connection sharing device.

10. A method of facilitating selection of a DNS provider to host a domain name for a user comprising:
automatically querying a DNS provider for terms of service via a purchasing component of a standardized message schema that is exchanged between the DNS provider and a user machine;
configuring a record of the DNS provider via a configuration component of the standardized message schema, to manage inbound traffic to the domain name of the user.

11. The method of claim 10 further comprising receiving a response by the user machine for plans offered by the DNS provider.

12. The method of claim 11 further comprising employing an XML as part of the standardized message schema.

13. The method of claim 11 further comprising configuring a mail record exchange of the DNS provider to associate with the domain name.

14. The method of claim 11 further comprising configuring an address record of the DNS provider to associate with the domain name.

15. The method of claim 11 further comprising configuring a reference record of the DNS provider to associate with the domain name.

16. The method of claim 11 further comprising receiving a user input for selection of an offered plan.

17. A computer readable medium having stored thereon computer executable instructions for carrying out the method of claim 10.

18. The method of claim 11 further comprising sending a billing query to the DNS provider.

19. The method of claim 18 further comprising receiving a response to the billing query by the user machine.

20. The method of claim 19 further comprising displaying terms of the service agreement to the user in a uniform format.

21. A computer-readable medium having stored thereon a data structure comprising:
a computer executable component that characterizes a service agreement of a DNS provider, as part of a standardized message schema exchanged between the DNS provider and a computer of an end user to host a domain name; and
a further computer executable component that configures a record associated with the domain name of the end user, to manage inbound traffic to the domain name.

22. The computer-readable medium of claim 21, the computer executable component further comprises a status query component that verifies ownership of the domain name.

23. The computer-readable medium of claim 21, the further computer executable component configures an address record of the DNS associated with the domain name, to point to an IP address of the computer.

24. The computer-readable medium of claim 21, the further computer executable component configures an MX record of the DNS associated with the domain name, to point to an IP address of the computer.

25. The computer-readable medium of claim 21 the further computer executable component configures a canonical name record of the DNS associated with the domain name, to point to an IP address of the computer.

26. The computer-readable medium of claim 21, a received response by the computer is displayed to an end user via a uniform presentation such that the user enjoys a similar experience, regardless of the DNS provider the user interacts with.

27. The computer-readable medium of claim 21 the standardized messages employ an XML format.

28. The computer readable medium of claim 21, further comprising an additional computer executable component that verifies entitlement of the domain name.

29. The computer readable medium of claim 21, the computer executable component provides for a transfer of the domain name from another DNS provider.

30. A system that facilitates hosting a domain name by a DNS provider comprising:
means for automatically characterizing a service agreement between a DNS provider and an end user computer; and
means for configuring the DNS provider that hosts the domain name.

31. The system of claim 30 further comprising graphic interface means for providing a uniform experience regardless of which DNS provider the user selects to interact with.

32. The system of claim 30 the graphic interface means comprises a description space for describing terms of service.
